(19) United States
(12) Patent Application Publication
(10) Pub. No.: US 2026/0222043 A1
(43) Pub. Date: Jul. 30, 2026

(54) RADIO NODE AND METHOD IN A COMMUNICATIONS NETWORK

(71) Applicant: Telefonaktiebolaget LM Ericsson (publ), Stockholm (SE)

(72) Inventors: Bo GÖRANSSON, SOLLENTUNA (SE); Jing RAO, SOLLENTUNA (SE); Martin ALM, MÖLNLYCKE (SE)

(73) Assignee: Telefonaktiebolaget LM Ericsson (publ), Stockholm (SE)

(21) Appl. No.: 19/145,540

(22) PCT Filed: Jan. 31, 2023
(86) PCT No.: PCT/EP2023/052255

§ 371 Date: Jul. 3, 2025

(51) Int. Cl. H04B 7/06

(52) U.S. Cl. CPC H04B 7/06952; H04B 7/0639

(57) ABSTRACT

A method for handling beam squint of a beam to be used for any one out of: a transmission or reception, between a first and second radio nodes at a second carrier frequency. The first radio node obtains a codebook designed for a first carrier frequency and a calculated correction value based on element separation of elements in an antenna array providing the beam, the first carrier frequency, the second carrier frequency and the codebook. The correction value relates to beam squint correction. The first radio node applies the calculated correction value to the obtained codebook to beam squint compensate the codebook to be applicable for said transmission or reception at the second carrier frequency. The first radio node performs the transmission to or reception at the second carrier frequency by applying the beam according to the beam squint compensated codebook.

### TECHNICAL FIELD

Embodiments herein relate to a first radio node and a methods therein. In some aspects, they relate to handling beam squint of a beam to be used for any one out of: a transmission or a reception, between the first radio node and a second radio node at a second carrier frequency in a wireless communications network.

### BACKGROUND

In a typical wireless communication network, wireless devices, also known as wireless communication devices, mobile stations, stations (STA) and/or User Equipment (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, with each service area or cell area being served by a radio network node such as a radio access node e.g., a Wi-Fi access point, a Base Station (BS) or a radio base station (RBS), which in some networks may also be denoted, for example, a Base Station (BS), a NodeB, eNodeB (eNB), or gNodeB (gNB) as denoted in Fifth Generation (5G) telecommunications. A service area or cell area is a geographical area where radio coverage is provided by the radio network node. The radio network node communicates over an air interface operating on a radio frequency with the wireless devices within the range of the radio network node.

3rd Generation Partnership Project (3GPP) is the standardization body for specifying the standards for the cellular system evolution, e.g., including 3G, 4G, 5G and the future evolutions. Specifications for Evolved Universal Terrestrial Radio Access (E-UTRA) and Evolved Packet System (EPS) have been completed within the 3GPP. In 4G also called a Fourth Generation (4G) network, EPS is core network and E-UTRA is radio access network. In 5G, 5GC is core network, NR is radio access network. As a continued network evolution, the new release of 3GPP specifies a 5G network also referred to as 5G New Radio (NR) and 5G Core (5GC).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station (BS), the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. The cell capacity can be increased linearly with respect to the number of antennas at the BS side. Due to that, more and more antennas are employed in BS. Such systems and/or related techniques are commonly referred to as massive MIMO.

5G NR may be used for so-called millimeter wave (mmWave), high band or FR2 frequency bands. Current and future mmWave systems are defined at frequency bands with large bandwidths. For example, 3GPP defined band n257 covers 26.50-29.50 GHz. These frequencies experience very high pathloss, and therefore large array antennas is used to generate high gain narrow beams. If a beamformer is implemented using phase shifters, beam squint may arise if large bandwidth should be supported. When a large bandwidth is supported in a system with beamforming, the frequency dependency of the beam pointing direction may be problematic. A beam defined for a certain frequency will point in a slightly different direction when applied at another frequency. This effect is referred to as beam squint. More in detail, an array response vector α(θ) is frequency dependent, and hence the beamforming vector will depend on the instantaneous carrier frequency. An array response vector when used herein e.g. means a response of a input signal, in other words the magnitude and phase of the output, as a function of the angle of a plane wave impinging onto the array.

FIG. 1 illustrates a planar wavefront impinging on a linear array. From FIG. 1 it is evident that it takes a planar wave

$$τ = \frac{d}{c} sin ( θ )$$

to travel between two adjacent elements, where c is speed of light. Since time shift and phase shift is equivalent for a sinusoidal signal with frequency f, this may also be expressed as

$$2 π f \frac{d}{c} sin ( θ ) = 2 π \frac{d}{λ} sin ( θ )$$

where λ is the wavelength of the carrier frequency.

From this it can be deduced that the phase shift of the wave between two elements is frequency dependent. This means that steering a beam towards the direction θ would require frequency dependent phase shifts, something that is cumbersome to implement by analog circuits. An alternative would be to implement the beamforming functionality using time delays. However, in practice this is normally very difficult.

Using a phase shifter implementation in a broadband system leads to beam squint. That is, using the same phase shift values for all frequencies leads to a beam pointing error for frequencies far from the frequency used in the design of the beamformer. Beam squint is normally not a problem for small arrays consisting of a few elements but may be fairly large for array sizes considered in mmWave systems. mmWave arrays can have several hundreds of antenna elements, for these large arrays that generate very narrow beams, beam squint may be a huge problem. The beam squint may be calculated from

$$Δ θ = arc sin ( \frac{{f}_{0}}{f} sin ( {θ}_{0} ) ) - {θ}_{0} .$$

Designing a beamformer for the mid frequency of n257 (f₀=28 GHz) and applying that at f=29.5 GHz results in a squint depicted in FIG. 2 illustrating a beam squint for a M=32 element array where the beam weights are designed for f0=28 GHz but applied for 29.5 GHz. For an array with M=32 elements (in one dimension), a typical beam width would be around 3°, and hence the beam squint is on the same order or larger than the 3 dB beamwidth when θ is larger than 45 degrees.

Even though a typical mmWave band is very wide (several GHz), it normally comprises several carriers. For example, 3GPP defines the carrier bandwidths {50, 100, 200, 400 MHz}. It is very common to use a 100 MHz channel configuration for the 3GPP bands defined so far. This means that a codebook, also referred to as a beam table, may be defined for each carrier frequency and by this circumvent the beam squint problem. The codebooks may be designed so that the beam points towards a certain direction, θ, regardless of the frequency. If the phase shifts in the beamforming vector is calculated from

$$2 π f \frac{d}{c} sin ( θ )$$

for each carrier frequency f, the beam squint problem disappears.

### SUMMARY

As a part of developing embodiments herein a problem was identified by the inventors and will first be discussed.

Using a specific codebook for each carrier frequency will resolve the beam squint problem. However, this would require several codebooks to be stored in the radio Digital Front End (DFE), or alternatively frequency specific weights sent to the DFE for every transmission/reception interval. The first option, to store several tables, would imply a very large memory in the DFE. Note that a typical codebook comprises several hundred beams to cover a certain coverage area. Sending carrier specific beam weights from e.g., a baseband unit to the radio node in each time interval would require a very large interface bandwidth. A typical implementation may support 10-20 carriers in a typical radio unit. This means that 10-20 beamforming vectors needs to be transferred each symbol. Alternatively, 10-20 codebooks need to be stored in the radio. E.g., an array antenna with 400 elements would require the same number of beamforming elements per beamforming vector. To cover a service area of ±60° in azimuth and ±15° in elevation approximately 800 beam are needed. The beam directions of a typical codebook of a two dimensional array are illustrated in FIG. 3.

An object of embodiments herein is to improve the performance in a communications network by providing an efficient way of handling beam squint.

According to an aspect of embodiments herein, the object is achieved by a method performed by a first radio node. The method is for handling beam squint of a beam to be used for any one out of: a transmission or reception, between the first radio node and a second radio node at a second carrier frequency in a wireless communications network. The first radio node obtains a codebook designed for a first carrier frequency. The first radio node obtains a calculated correction value based on element separation of elements in an antenna array providing the beam, the first carrier frequency, the second carrier frequency and the codebook designed for the first carrier frequency. The correction value relates to beam squint correction. The first radio node applies the calculated correction value to the obtained codebook designed for the first carrier frequency to beam squint compensate the codebook to be applicable for said transmission or reception at the second carrier frequency. The first radio node performs the transmission to or reception from the second radio node at the second carrier frequency by applying the beam according to the beam squint compensated codebook.

According to another aspect of embodiments herein, the object is achieved by a first radio node configured to handle beam squint of a beam to be used for any one out of: a transmission or reception, between the first radio node and a second radio node at a second carrier frequency in a wireless communications network. The first radio node is further configured to:

Obtain a codebook designed for a first carrier frequency,
calculate a correction value based on: element separation of elements in an antenna array providing the beam, the first carrier frequency, the second carrier frequency and the codebook designed for the first carrier frequency, wherein the correction value is adapted to relate to beam squint correction,
apply the calculated correction value to the obtained codebook designed for the first carrier frequency to beam squint compensate the codebook to be applicable for said transmission or reception at the second carrier frequency, and
perform the transmission to or reception from the second radio node at the second carrier frequency by applying the beam according to the beam squint compensated codebook.

An advantage of example embodiments of the method disclosed herein comprises a saving in a memory since only one table needs to be stored, or that only one beam weight or beam index, and only one correction factor needs to be transferred to the digital front end, or alternatively, be used to correct the codebook stored in the DFE. This is in contrast to existing solutions where either a beam vector per carrier needs to be transferred over the interface, or one codebook per carrier needs to be stored in the radio, DFE or Analog Front End (AFE).

### BRIEF DESCRIPTION OF THE DRAWINGS

Examples of embodiments herein are described in more detail with reference to attached drawings in which:

FIG. 1 is a schematic diagram illustrating prior art.

FIG. 2 is a schematic diagram illustrating prior art.

FIG. 3 is a schematic diagram illustrating prior art.

FIG. 4 is a schematic block diagram illustrating embodiments of a wireless communications network.

FIG. 5 is a flowchart depicting an embodiment of a method in a first radio node.

FIG. 6 is a diagram illustrating prior art to be compared with FIG. 7.

FIG. 7 is a diagram illustrating an example scenario of embodiments herein.

FIG. 8 is a schematic block diagram illustrating embodiments of a first radio node.

FIG. 9 schematically illustrates a telecommunication network connected via an intermediate network to a host computer.

FIG. 10 is a generalized block diagram of a host computer communicating via a base station with a user equipment over a partially wireless connection.

FIGS. 12-14 are flowcharts illustrating methods implemented in a communication system including a host computer, a base station, and a user equipment.

### DETAILED DESCRIPTION

Examples of embodiments herein may relate to compensating a codebook for beam squint.

An alternative to have one codebook, also referred to as beam table, for each carrier frequency, or potentially group of carriers, as in prior art, is to calculate a correction value according to embodiments herein, to be used to update a codebook designed for a first carrier frequency f₁, when applied to a second carrier frequency f₂. By examples of embodiments herein, only one correction factor needs to be transmitted to the digital front end together with a beamindex, or alternatively, be used to correct the codebook stored in the DFE.

It should be noted that the beam squint is dependent on the frequency and/or wavelength, a difference in distance between two frequency carriers, and also on the pointing, also referred to as tilt, direction of the beam. Thus, a beam pointing close to broadside may not need squint compensation, and hence some beam indices do not need to be corrected even for carriers far from f₁.

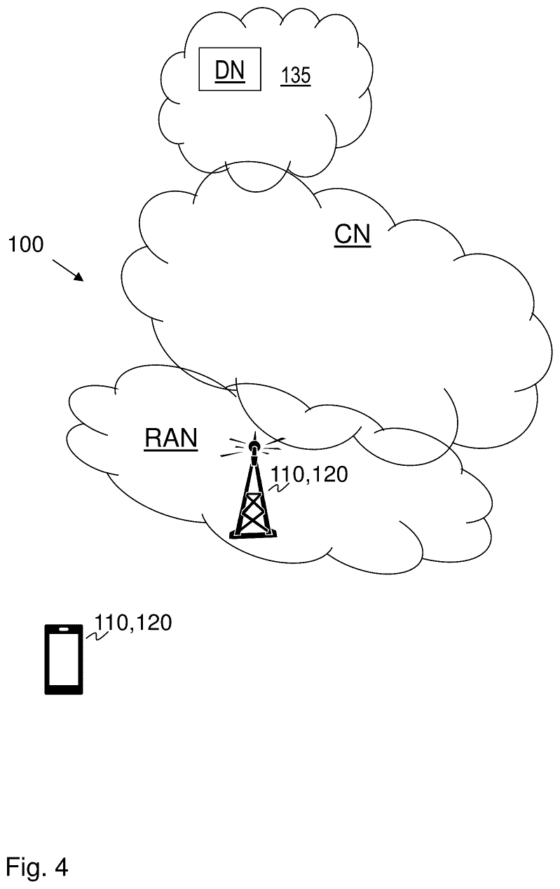

FIG. 4 is a schematic overview depicting a communications network 100, such as e.g. a wireless communications network, wherein embodiments herein may be implemented. The communications network 100 comprises one or more RANs and one or more CNs. The communications network 100 may use 5G NR but may further use a number of other different technologies, such as, 6G, Wi-Fi, (LTE), LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Radio nodes, such as a first radio node 110, operate in the communications network 100. The first radio node 110 e.g. provides a number of cells and may use these cells for communicating with other radio nodes, such as e.g. a second radio node 120 which may be a UE. The first radio node 110 may be a transmission and reception point e.g. a network node, a radio access network node such as a base station, a radio base station, a NodeB, an evolved Node B (eNB, eNodeB, eNode B), an NR/g Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE served by the first radio node 110 depending e.g. on the radio access technology and terminology used.

In some embodiments herein, the first radio node 110 may be a UE.

Radio nodes, such as the second radio node 120, operate in the communications network 100. The second radio node 120 may e.g. be a UE, an NR device, a mobile station, a wireless terminal, an NB-IoT device, an enhanced Machine Type Communication (eMTC) device, an NR RedCap device, a CAT-M device, a Vehicle-to-everything (V2X) device, Vehicle-to-Vehicle (V2V) device, a Vehicle-to-Pedestrian (V2P) device, a Vehicle-to-Infrastructure (V2I) device, and a Vehicle-to-Network (V2N) device, a Wi-Fi device, an LTE device and a non-access point (non-AP) STA, a STA, that communicates via a base station such as e.g. the network node 110, one or more Access Networks (AN), e.g. RAN, to one or more core networks (CN). It should be understood by the skilled in the art that the term UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

In some embodiments herein, the second radio node 120 may be a radio network node such as a gNB.

Thus, the first radio node 110 may be represented by a radio network node such as e.g. gNB, and the second radio node 120 may be represented by a UE. This is shown in FIG. 4. In some embodiments it may be the other way around, the first radio node 110 is represented by a UE and the second radio node 120 is represented by a radio network node such as e.g. a gNB.

Methods herein may in one aspect be performed by the first radio node 110. As an alternative, a Distributed Node (DN) and functionality, e.g. comprised in a cloud 135 as shown in FIG. 4, may be used for performing or partly performing the methods of embodiments herein.

According to example embodiments herein, a beam squint correction value, also referred to as beam squint correction factor, e.g., a one phase value, is calculated. The beam squint correction value is then used to correct the codebook for any beam squint that may occur due to the frequency difference between the frequency assumed when designing the codebook, and the frequency where the codebook is applied.

A number of embodiments will now be described, some of which may be seen as alternatives, while some may be used in combination.

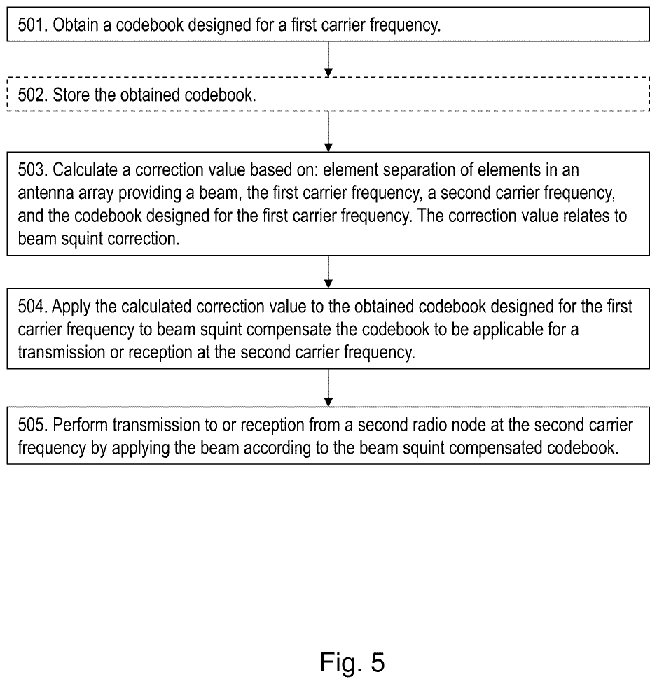

FIG. 5 shows exemplary embodiments of a method performed by the first radio node 110. The method is for handling beam squint of a beam to be used for any one out of: a transmission or reception, between the first radio node 110 and the second radio node 120 at a second carrier frequency f2 in the wireless communications network 100.

This e.g. means that the method is for handling beam squint of a beam to be used for any one out of: a transmission or reception, beam squint in a transmission between, i.e. in any of DL and UL, the first radio node 110 and the second radio node 120, or for handling beam squint in a reception, i.e. in any of DL and UL, between the first radio node 110 and the second radio node 120. In other words the method relates to transmitting in DL and UL and receiving in DL and UL.

In some embodiments, the first radio node 110 is represented by a radio network node and the second radio node 120 is represented by a User Equipment, UE. In some other embodiments, the first radio node 110 is represented by a UE and the second radio node 120 is represented by a radio network node.

The method comprises the following actions, which actions may be taken in any suitable order.

### Action 501

The first radio node 110 obtains a codebook designed for a first carrier frequency f1.

The codebook designed for the first carrier frequency f1 will according to embodiments herein, later on be applied together with a correction value to compensate for beam squint when used for a second carrier frequency f2.

The codebook designed for a first carrier frequency f1 may be transferred to the first radio node 110 at system start up, and be stored in a memory in the first radio node 110. Alternatively, the codebook is transferred to the first radio node 110 at production.

### Action 502

In some embodiments, the first radio node 110 stores the obtained codebook designed for the first carrier frequency f1 to be accessible by the first radio node 110. As an example, the obtained codebook designed for the first carrier frequency f1 may be stored in a DFE to be accessible by the first radio node 110. According to embodiments herein, an advantage is that only one codebook defined for one carrier frequency needs to be stored. The codebook is stored e.g. in a memory in the first radio node 110 or in the DFE in such that it is accessible and can be retrieved later on by the first radio node 110. The one codebook defined for one carrier frequency will then be used on other carrier frequencies together with a correction value to compensate for beam squint.

### Action 503

The first radio node 110 obtains a calculated correction value. The calculation is based on element separation of elements in an antenna array providing the beam, the first carrier frequency f1, the second carrier frequency f2 and the codebook designed for the first carrier frequency f1. The correction value relates to beam squint correction.

As hinted above, the correction value will then be used to correct a codebook for any beam squint that may occur due to a frequency difference between the first frequency carrier f1 assumed when designing the codebook, and the second frequency carrier f2 where the codebook is to be applied.

The first radio node 110 may obtain the calculated correction value by calculate the correction value itself and later on apply this to the codebook if used at e.g., second carrier frequency f2. An alternative implementation may be to obtain the calculated correction value from any other node, and store this value or values, one per frequency other than f1 together with the codebook. When transmitting/receiving on f2, the beamforming vector for this case will then be compensated with the correction value.

The first radio node 110 may perform the calculation of the correction value when the second radio node 120 is scheduled on the second carrier frequency f2 for said transmission or reception. In other words, the radio node 110 may be triggered to perform the calculation of the correction value when the second radio node 120 is scheduled on the second carrier frequency f2 for said transmission or reception.

An example of how to calculate the correction value will be described below.

### Action 504

The first radio node 110 then applies the calculated correction value to the obtained codebook designed for the first carrier frequency f1 to beam squint compensate the codebook to be applicable for said transmission or reception at the second carrier frequency f2. The application of the calculated correction value to the obtained codebook may be performed by the DFE.

### Action 505

The first radio node 110 performs the transmission to, or reception from, the second radio node 120 at the second carrier frequency f2 by applying the beam according to the beam squint compensated codebook.

In this way the beam will be pointing in the intended direction thereby increasing the gain towards the second radio node 120.

Embodiments herein such as the embodiments mentioned above will now be further described and exemplified. The text below is applicable to and may be combined with any suitable embodiment described above.

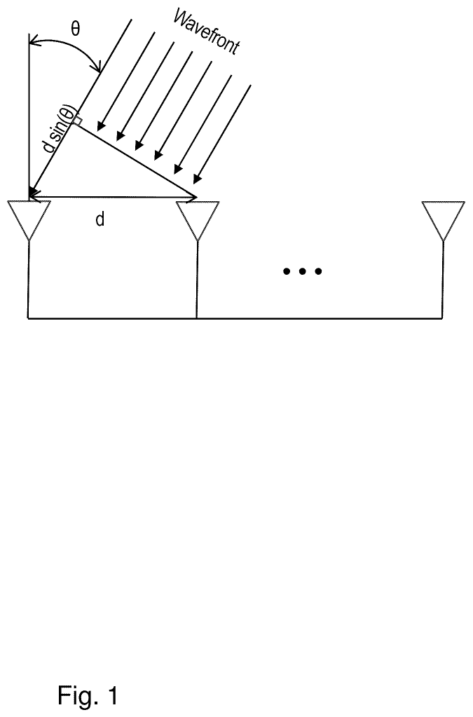

For simplicity, the following text derive the beam squint compensation factor for a linear array where the direction to a source is given by the direction θ. In the case of a planar array, the direction to a source will be given by the pair (θ, φ). The extension to the planar array case is done by considering each dimension separately. The array response vector for a M element array at a wavelength A may be expressed as follows from FIG. 1.

$$a ( θ , {λ}_{1} ) = [ \begin{matrix}1 \\ {e}^{j 2 π \frac{d 1}{{λ}_{1 :}} sin ( θ )} \\ ⋮ \\ {e}^{j 2 π ( M - 1 ) \frac{d}{{λ}_{1}} sin ( θ )}\end{matrix} ]$$

This describes the resulting phase shift over the array from a planar wave impinging from direction θ at a first frequency f1 related to the first carrier frequency f1, or equivalently first wavelength λ₁. Assume that the beamforming vector w₁ is used to generate a certain beam at the first wavelength λ₁. Assume now that it is wanted to generate the same beam at a different second frequency f₂ related to the second carrier frequency f2, that is

$${w}_{1}^{*} a ( θ , {λ}_{1} ) = {w}_{2}^{*} a ( θ , {λ}_{2} ) .$$

The k^{th} element of the array response vector is given by:

$$a ( θ , {λ}_{1} , k ) = {e}^{j 2 π \frac{d}{{λ}_{1}} k sin ( θ )} = {e}^{j k {ψ}_{1}} = {e}^{j k ( {ψ}_{1} + {ψ}_{2} - {ψ}_{2} )} = {e}^{j k {ψ}_{2}} {e}^{j k ( {ψ}_{1} - {ψ}_{2} )} = a ( θ , {λ}_{2} , k ) {e}^{j k ( {ψ}_{1} - {ψ}_{2} )} = a ( θ , {λ}_{2} , k ) ∘ t ( k )$$

where k=0, 1, 2 . . . , M−1 and where

$${ψ}_{i} = 2 π \frac{d}{{λ}_{i}} sin ( θ ) ,$$

where i=1, 2.

Hence a(θ,λ₁)=tºa(θ,λ₂) where º represents element-wise multiplication.

This results in

$${w}_{1}^{*} a ( θ , {λ}_{1} ) = {w}_{1}^{*} ( t ∘ a ( θ , {λ}_{2} ) ) = ( {w}_{1}^{*} ∘ {t}^{*} ) a ( θ , {λ}_{2} )$$

That is, the codebook vector w₁ should be compensated with the correction value, referred to as the term t here, to result in the same beamform at the second carrier frequency f₂.

The inverse wavelength may be expressed as

$$\frac{1}{λ} = \frac{f}{c}$$

where f denotes the carrier frequency and c is the speed of light, and hence the correction value

$$t ( k ) = {e}^{j k ( {ψ}_{1} - {ψ}_{2} )} = {e}^{j 2 π k \frac{d}{c} sin ( θ ) ( {f}_{1} - {f}_{2} )} = {α ( θ , {f}_{1} , {f}_{2} )}^{k}$$

From this it is evident that element k of the beamforming vector for the second carrier frequency f₂ should be compensated by a correction value here comprising a phase shift given by α(θ, f₁, f₂)^{k} to fit the second carrier frequency f₂.

This means that only one phase shift a is needed to correct the beamforming vector w₁ when used at another frequency, say second carrier frequency f₂.

Two different implementations may be envisaged, first a single codebook designed for the first carrier frequency f₁ may be stored in e.g., the DFE and when a UE, e.g. the first or second radio node 110, 120, is scheduled on a different carrier, say second carrier frequency f₂, the frequency dependent correction value, in this example the phase correction factor α, is sent to the beamformer e.g. of the first radio node 110, which will correct the applied weights vector according to the correction value, by α^{k} per branch. By this, only a single codebook designed for a specific frequency, such as the first carrier frequency f1, needs to be stored. Note that the beam squint compensation value is carrier specific and if several component carriers are transmitted, a unique correction value, such as α, per carrier is needed. In such a case a correction value, such as a vector, comprising squint compensations may be sent to the DFE. Or as an alternative, if signaling is done per component carrier, the correction value, such as α, may be sent together with the beam index for each carrier frequency.

Alternatively, only one codebook is needed in the baseband part of the first or second radio node 110, 120. The baseband may be a part of the first or second radio node 110, 120, but it may also be a separate node for example located in the cloud 135. Beam vectors needed for other frequencies may be calculated on the fly based on the correction value α^{k}. In any case embodiments herein provide huge savings in either storage (memory) or in the capacity of the signaling interface.
the first carrier frequency f1 is referred to as a target carrier frequency, and the second carrier frequency f2 is referred to as an additional frequency also scheduled, in the examples below.

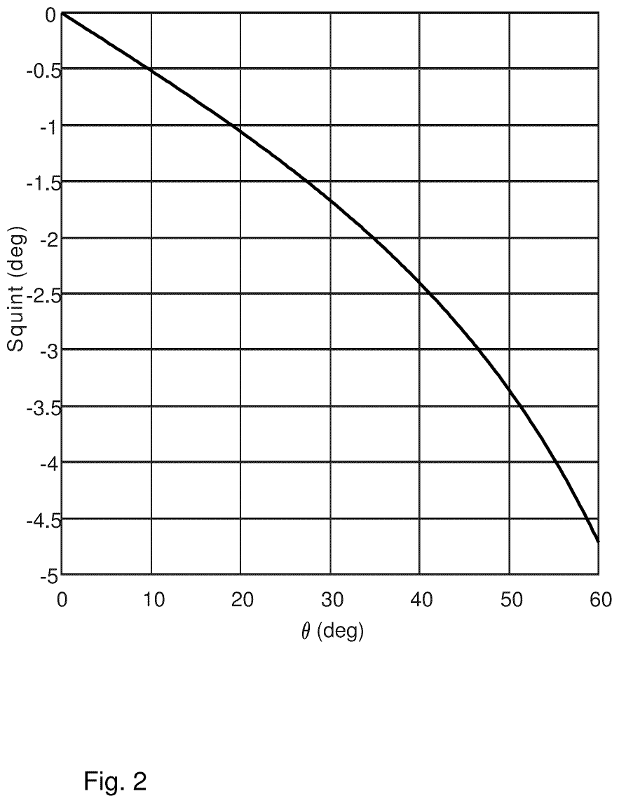

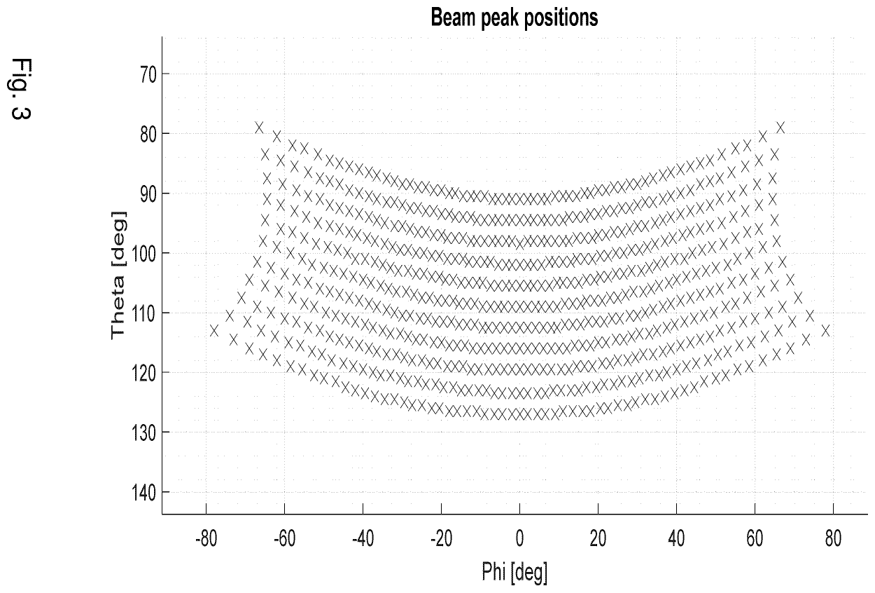

In what follows, a small numerical example is given. The following example will only address a 1 Dimension (1D) antenna array, a linear array, but the extension to a 2D array as the one exemplified in FIG. 2 and FIG. 3 is straightforward. Assume an M=32 element uniform linear antenna array. The target carrier frequency f₁=28 GHz, and the λ/2 element separation is thus d=5.36 mm. It is further assumed that the system is also used at f₂=29.5 GHz, which means that beam squint will occur relative beams designed for f₁. A 64-element DFT codebook is used, uniformly sampled linear phase fronts, and the beam indices are relative beams at f₁. A UE, such as the first or second radio node 110, 120, is placed in the direction θ=45° relative broadside of the antenna array.

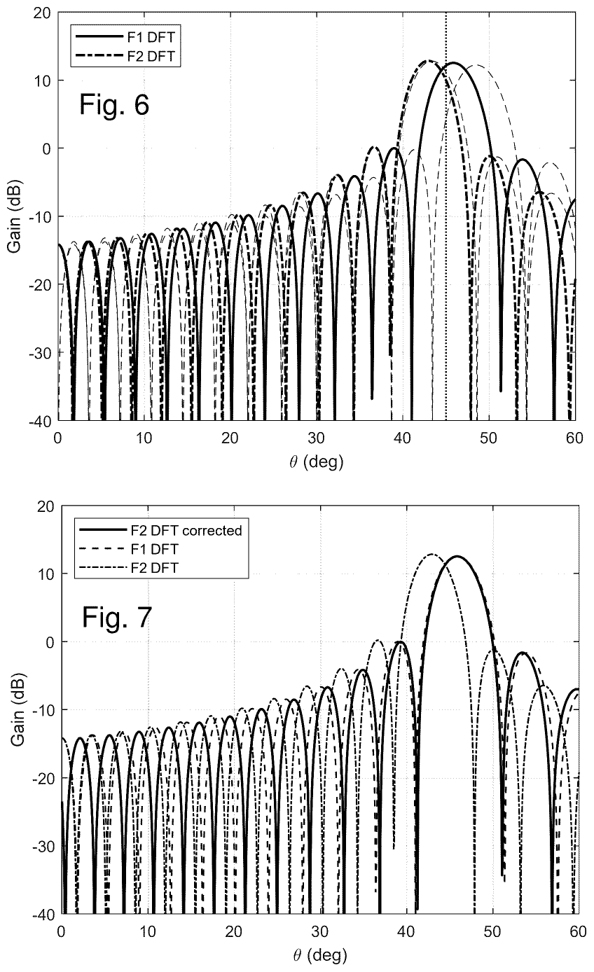

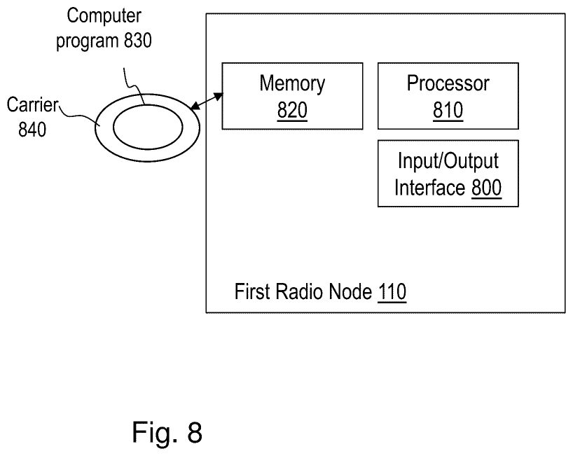

FIG. 6 illustrates beam patterns for a DFT based codebook used at frequency f₁ (-) and f₂ (-.). It further shows a three beams from the DFT codebook (--) for frequency f₁ and the squinted beam (-.) for frequency f₂. FIG. 6 shows the beam when not being corrected according to prior art, it shows the beam for f1 where the codebook is defined and f2 when the same codebook indexing is used, i.e. not corrected. FIG. 6 is to be compared with FIG. 7 illustrating when correction value is applied to the codebook according to embodiments herein. The correction value is applied to the codebook here referred to as DFT weight vector, at the second carrier frequency f₂, hence w₂=tºw₁. This is shown in FIG. 7 illustrating that the beam squint is corrected to avoid squint. Note that in this case the correction value α is calculated using the direction, θ, of the DFT beam. In other words, FIG. 7 illustrates a beam pattern for f₂ before (-.) and after (-) correction. After squint correction the corrected beam at f₂ is aligned with the corresponding beam at f₁.

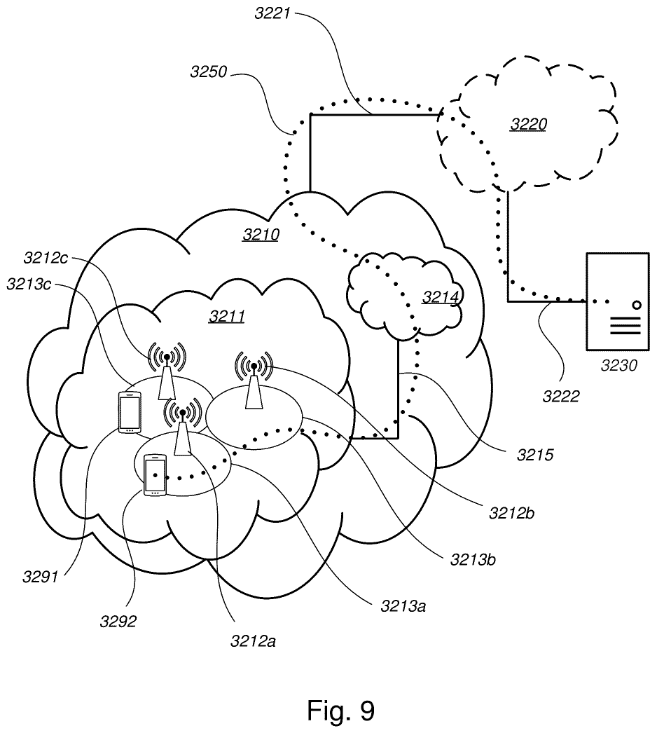

FIG. 8 illustrates an example of an arrangement in the first radio node 110.

The first radio node 110 is configured to handle beam squint of a beam to be used for any one out of: a transmission or reception, between the first radio node 110 and the second radio node 120 at a second carrier frequency f2 in the wireless communications network 100.

The first radio node 110 may comprise an input and output interface 800 configured to communicate e.g., with any of the networking entities operating in the communications network 100 of embodiments herein such as e.g., the second radio node 120. The input and output interface 800 may comprise a receiver, e.g., wired and/or wireless, (not shown) and a transmitter, e.g., wired and/or wireless, (not shown).

The first radio node 110 is further configured to obtain a codebook designed for a first carrier frequency f1.

In some embodiments, the first radio node 110 is further configured to store the obtained codebook designed for the first carrier frequency f1 to be accessible by the first radio node 110. The obtained codebook designed for the first carrier frequency f1 may be adapted to be stored in a DFE to be accessible by the first radio node 110.

The first radio node 110 is further configured to obtain calculated correction value based on: element separation of elements in an antenna array providing the beam, the first carrier frequency f1, the second carrier frequency f2 and the codebook designed for the first carrier frequency f1. The correction value is adapted to relate to beam squint correction.

In some embodiments, the first radio node 110 is configured to calculate the correction value when the second radio node 120 is scheduled on the second carrier frequency f2 for said transmission or reception.

The first radio node 110 is further configured to apply the calculated correction value to the obtained codebook designed for the first carrier frequency f1 to beam squint compensate the codebook to be applicable for said transmission or reception at the second carrier frequency f2.

The first radio node 110 is further configured to perform the transmission to or reception from the second radio node 120 at the second carrier frequency f2 by applying the beam according to the beam squint compensated codebook.

In some embodiments, any one out of:
the first radio node 110 is adapted to be represented by a radio network node and the second radio node 120 is adapted to be represented by a UE, or
the first radio node 110 is adapted to be represented by a UE and the second radio node 120 is adapted to be represented by a radio network node.

The embodiments herein may be implemented through a respective processor or one or more processors, such as at least one processor 810 of a processing circuitry in the first radio node 110 depicted in FIG. 8, together with computer program code for performing the functions and actions of the embodiments herein. The program code mentioned above may also be provided as a computer program product, for instance in the form of a data carrier carrying computer program code for performing the embodiments herein when being loaded into the first radio node 110. One such carrier may be in the form of a CD ROM disc. It is however feasible with other data carriers such as a memory stick. The computer program code may furthermore be provided as pure program code on a server and downloaded to the first radio node 110.

The first radio node 110 may further comprise a memory 820 comprising one or more memory units. The memory 820 comprises instructions executable by the processor in the first radio node 110. The memory 820 is arranged to be used to store instructions, data, configurations, measurements, parameters, and applications to perform the methods herein when being executed in the first radio node 110.

In some embodiments, a computer program 830 comprises instructions, which when executed by the at least one processor 810, cause the at least one processor 810 of the first radio node 110 to perform the actions above.

In some embodiments, a respective carrier 840 comprises the respective computer program 830, wherein the carrier 840 is one of an electronic signal, an optical signal, an electromagnetic signal, a magnetic signal, an electric signal, a radio signal, a microwave signal, or a computer-readable storage medium.

Those skilled in the art will also appreciate that any functional modules in the first radio node 110, described below may refer to a combination of analogue and digital circuits, and/or one or more processors configured with software and/or firmware, e.g., stored in the first radio node 110, that when executed by the respective one or more processors such as the at least one processor 810 described above cause the respective at least one processor 810 to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

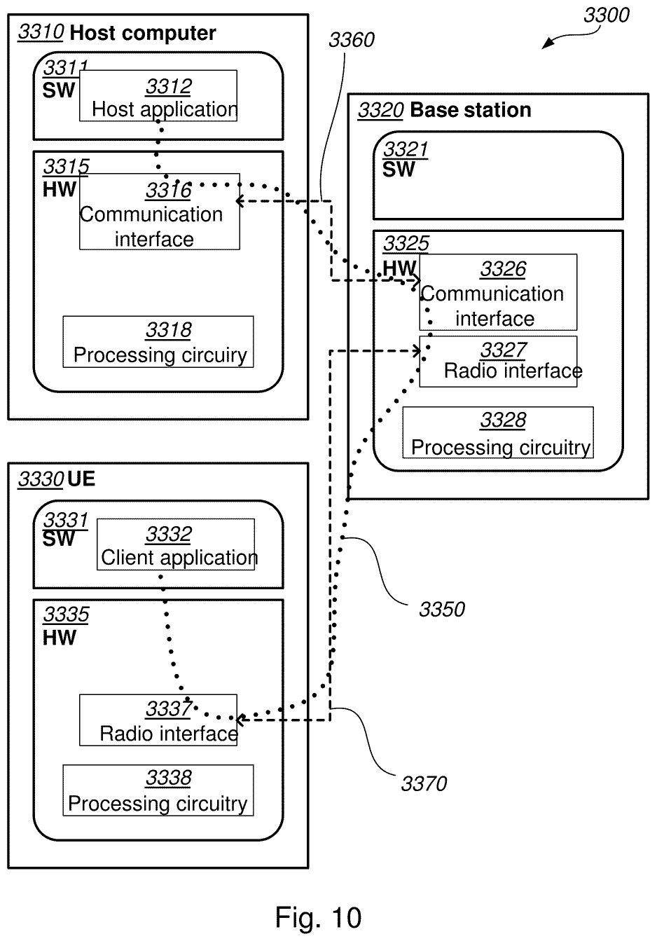

With reference to FIG. 9, in accordance with an embodiment, a communication system includes a telecommunication network 3210, such as a 3GPP-type cellular network, e.g. communications network 100, which comprises an access network 3211, such as a radio access network, and a core network 3214. The access network 3211 comprises a plurality of base stations 3212a, 3212b, 3212c, e.g., the first radio node 110 or the second radio node 120, such as AP STAs NBs, eNBs, gNBs or other types of wireless access points, each defining a corresponding coverage area 3213a, 3213b, 3213c. Each base station 3212a, 3212b, 3212c, e.g. radio network nodes 141,142, is connectable to the core network 3214 over a wired or wireless connection 3215. A first user equipment (UE), e.g. the first radio node 110 or the second radio node 120, such as a Non-AP STA 3291 located in coverage area 3213c is configured to wirelessly connect to, or be paged by, the corresponding base station 3212c, e.g., the network node 110. A second UE 3292, e.g., any of the one or more second UEs 122, such as a Non-AP STA in coverage area 3213a is wirelessly connectable to the corresponding base station 3212a, e.g., the network node 110. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 9 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

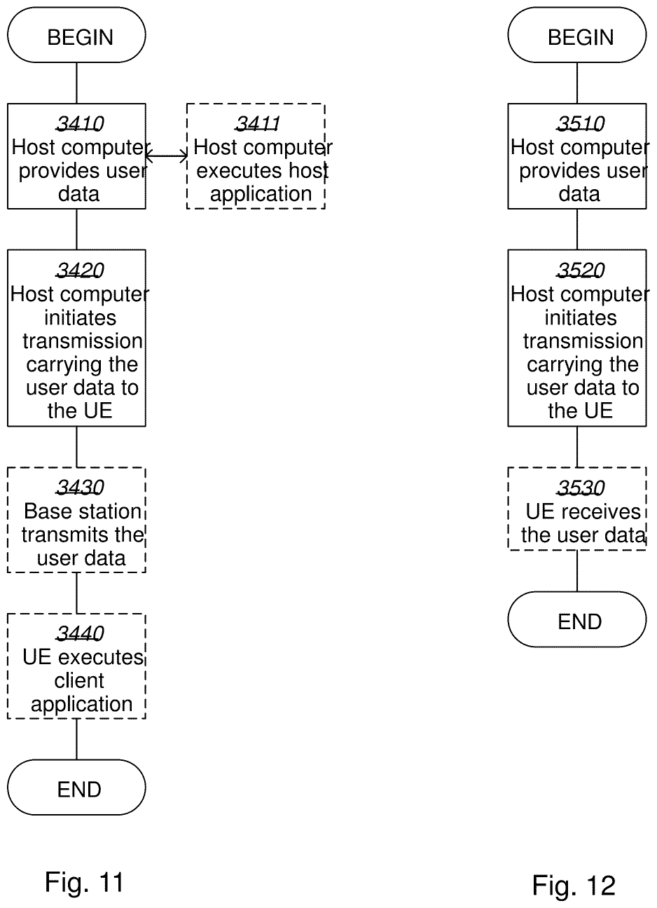

Example implementations, in accordance with an embodiment, of the UE, base station and host computer discussed in the preceding paragraphs will now be described with reference to FIG. 10. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 10) served by the base station 3320. The communication interface 3326 may be configured to facilitate a connection 3360 to the host computer 3310. The connection 3360 may be direct or it may pass through a core network (not shown in FIG. 10) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 10 may be identical to the host computer 3230, one of the base stations 3212a, 3212b, 3212c and one of the UEs 3291, 3292 of FIG. 9, respectively. This is to say, the inner workings of these entities may be as shown in FIG. 10 and independently, the surrounding network topology may be that of FIG. 9.

In FIG. 10, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the RAN effect: data rate, latency, power consumption and thereby provide benefits such as e.g. the applicable corresponding effect on the OTT service: reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

FIG. 11 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 10. For simplicity of the present disclosure, only drawing references to FIG. 11 will be included in this section. In a first Step 2410 of the method, the host computer provides user data. In an optional sub Step 2411 of the first Step 2410, the host computer provides the user data by executing a host application. In a second Step 2420, the host computer initiates a transmission carrying the user data to the UE. In an optional third Step 2430, the base station transmits to the UE the user data which was carried in the transmission that the host computer initiated, in accordance with the teachings of the embodiments described throughout this disclosure. In an optional fourth Step 2440, the UE executes a client application associated with the host application executed by the host computer.

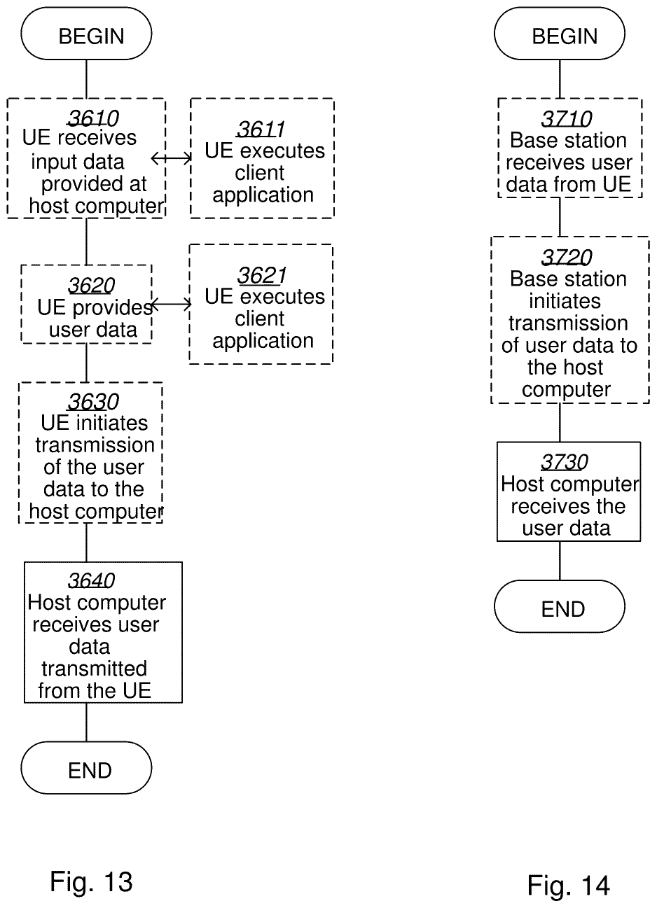

FIG. 12 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 10. For simplicity of the present disclosure, only drawing references to FIG. 12 will be included in this section. In a first Step 2510 of the method, the host computer provides user data. In an optional sub step (not shown) the host computer provides the user data by executing a host application. In a second Step 2520, the host computer initiates a transmission carrying the user data to the UE. The transmission may pass via the base station, in accordance with the teachings of the embodiments described throughout this disclosure. In an optional third Step 2530, the UE receives the user data carried in the transmission.

FIG. 13 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 10. For simplicity of the present disclosure, only drawing references to FIG. 13 will be included in this section. In an optional first Step 2610 of the method, the UE receives input data provided by the host computer. Additionally or alternatively, in an optional second Step 2620, the UE provides user data. In an optional sub Step 2621 of the second Step 2620, the UE provides the user data by executing a client application. In a further optional sub Step 2611 of the first Step 2610, the UE executes a client application which provides the user data in reaction to the received input data provided by the host computer. In providing the user data, the executed client application may further consider user input received from the user. Regardless of the specific manner in which the user data was provided, the UE initiates, in an optional third sub Step 2630, transmission of the user data to the host computer. In a fourth Step 2640 of the method, the host computer receives the user data transmitted from the UE, in accordance with the teachings of the embodiments described throughout this disclosure.

FIG. 14 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 10. For simplicity of the present disclosure, only drawing references to FIG. 14 will be included in this section. In an optional first Step 2710 of the method, in accordance with the teachings of the embodiments described throughout this disclosure, the base station receives user data from the UE. In an optional second Step 2720, the base station initiates transmission of the received user data to the host computer. In a third Step 2730, the host computer receives the user data carried in the transmission initiated by the base station.

When using the word “comprise” or “comprising” it shall be interpreted as non-limiting, i.e. meaning “consist at least of”.

The embodiments herein are not limited to the preferred embodiments described above. Various alternatives, modifications and equivalents may be used.

1. A method performed by a first radio node for handling beam squint of a beam to be used for any one out of: a transmission or reception, between the first radio node and a second radio node at a second carrier frequency (f2) in a wireless communications network, the method comprising:
obtaining a codebook designed for a first carrier frequency (f1);
obtaining a calculated correction value based on: element separation of elements in an antenna array providing the beam, the first carrier frequency (f1), the second carrier frequency (f2) and the codebook designed for the first carrier frequency (f1), wherein the correction value relates to beam squint correction;
applying the calculated correction value to the obtained codebook designed for the first carrier frequency (f1) to beam squint compensate the codebook to be applicable for said transmission or reception at the second carrier frequency (f2); and
performing the transmission to or reception from the second radio node at the second carrier frequency (f2) by applying the beam according to the beam squint compensated codebook.

2. The method according to claim 1, further comprising:
storing the obtained codebook designed for the first carrier frequency (f1) to be accessible by the first radio node.

3. The method according to claim 2, wherein the obtained codebook designed for the first carrier frequency (f1) is stored on a Digital Front End, DFE, to be accessible by the first radio node.

4. The method according to claim 1, wherein the calculating, of the correction value is performed when the second radio node is scheduled on the second carrier frequency (f2) for said transmission or reception.

5. The method according to claim 1, wherein any one out of:
the first radio node is represented by a radio network node and the second radio node is represented by a User Equipment, UE, or
the first radio node is represented by a UE and the second radio node is represented by a radio network node.

6.-7. (canceled)

8. A first radio node configured to handle beam squint of a beam to be used for any one out of: a transmission or reception, between the first radio node and a second radio node at a second carrier frequency (f2) in a wireless communications network, the first radio node further being configured to:
obtain a codebook designed for a first carrier frequency (f1);
obtain a calculated correction value based on: element separation of elements in an antenna array providing the beam, the first carrier frequency (f1), the second carrier frequency (f2) and the codebook designed for the first carrier frequency (f1), wherein the correction value is adapted to relate to beam squint correction;
apply the calculated correction value to the obtained codebook designed for the first carrier frequency (f1) to beam squint compensate the codebook to be applicable for said transmission or reception at the second carrier frequency (f2); and
perform the transmission to or reception from the second radio node at the second carrier frequency (f2) by applying the beam according to the beam squint compensated codebook.

9. The first radio node according to claim 8, further configured to:
store the obtained codebook designed for the first carrier frequency (f1) to be accessible by the first radio node.

10. The first radio node according to claim 9, wherein the obtained codebook designed for the first carrier frequency (f1) is adapted to be stored on a Digital Front End, DFE, to be accessible by the first radio node.

11. The first radio node according to claim 8, wherein the first radio node is configured to calculate the correction value when the second radio node is scheduled on the second carrier frequency (f2) for said transmission or reception.

12. The first radio node according to claim 8, wherein any one out of:
the first radio node is adapted to be represented by a radio network node and the second radio node is adapted to be represented by a User Equipment, UE, or
the second radio node is adapted to be represented by a radio network node.

13. A non-transitory computer readable medium including program code to be executed by processing circuitry of a first radio node configured to handle beam squint of a beam to be used for any one out of: a transmission or reception, between the first radio node and a second radio node at a second carrier frequency (f2) in a wireless communications network, whereby execution of the program code causes the program code to perform operations comprising:
obtain a codebook designed for a first carrier frequency (f1);
obtain a calculated correction value based on: element separation of elements in an antenna array providing the beam, the first carrier frequency (f1), the second carrier frequency (f2) and the codebook designed for the first carrier frequency (f1), wherein the correction value is adapted to relate to beam squint correction;
apply the calculated correction value to the obtained codebook designed for the first carrier frequency (f1) to beam squint compensate the codebook to be applicable for said transmission or reception at the second carrier frequency (f2); and
perform the transmission to or reception from the second radio node at the second carrier frequency (f2) by applying the beam according to the beam squint compensated codebook.

14. The non-transitory computer readable medium according to claim 13, wherein the operations further comprise:
store the obtained codebook designed for the first carrier frequency (f1) to be accessible by the first radio node.

15. The first radio node according to claim 14, wherein the obtained codebook designed for the first carrier frequency (f1) is adapted to be stored on a Digital Front End, DFE, to be accessible by the first radio node.

16. The non-transitory computer readable medium according to claim 13, wherein the first radio node is configured to calculate the correction value when the second radio node is scheduled on the second carrier frequency (f2) for said transmission or reception.

17. The non-transitory computer readable medium according to claim 13, wherein any one out of:
the first radio node is adapted to be represented by a radio network node and the second radio node is adapted to be represented by a User Equipment, UE, or
the second radio node is adapted to be represented by a radio network node.
